(19) United States
(12) Patent Application Publication
(10) Pub. No.: US 2015/0309683 A1
(43) Pub. Date: Oct. 29, 2015

(54) Method for displaying input text in interface and interface component for displaying input text

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventor: Jiakuan Ying, BEIJING (CN)

(21) Appl. No.: 14/647,540

(22) PCT Filed: Nov. 29, 2013
(86) PCT No.: PCT/CN2013/088202

§ 371 Date: May 27, 2015

(30) Foreign Application Priority Data
Nov. 30, 2012 (CN) 201210507473.1
Nov. 30, 2012 (CN) 201210507816.4

(51) Int. Cl. G06F 3/0484; G06F 17/24; H04L 29/08

(52) U.S. Cl. CPC G06F 3/0484; H04L 67/10; G06F 17/242

(57) ABSTRACT

The invention provides a method for displaying an input text in an interface and an interface component for displaying an input text. The display method comprises: disposing a first textarea in the interface; disposing a second textarea in the interface, the second textarea being arranged behind the first textarea, such that the position of the second textarea corresponds to the position of the first textarea; receiving an input text in the first textarea, and displaying the input text in a first predetermined format; and displaying the text input in the first textarea in the second textarea in a second predetermined format, such that the input text is displayed at the same positions in the first textarea and in the second textarea, and that the input text is displayed superposedly in the first predetermined format and in the second predetermined format. The invention may solve the problem that an input text in a textarea can not be automatically displayed according to a different format, and may present a more friendly interface to a user.

### FIELD OF THE INVENTION

The invention relates to the field of computer technologies, and in particular, to a method for displaying an input text in an interface and an interface component for displaying an input text.

### BACKGROUND OF THE INVENTION

In a multi-line textarea configured in an interface, a user may enter one or more segment of text. When one or more segment of text is entered in a multi-line textarea, the text in the multi-line textarea will only show a default font color (e.g., black), and if it is needed to change the font color of part of the text in the multi-line textarea, for example, change the font color of part of the text from black into red, the user needs to manually adjust the font color of the text.

Therefore, there is a need for a solution which may solve the problem of, for example, automatically setting an input text in a multi-line textarea to different formats and displaying it.

### SUMMARY OF THE INVENTION

In view of the above problems, the invention is proposed to provide a method for displaying an input text in an interface and an interface component for displaying an input text, which overcome the above problems or at least in part solve the above problems.

According to an aspect of the invention, there is provided a method for displaying an input text in an interface comprising the steps of: disposing a first textarea in the interface; disposing a second textarea in the interface, the second textarea being arranged behind the first textarea, such that the position of the second textarea corresponds to the position of the first textarea; receiving an input text in the first textarea, and displaying the input text in a first predetermined format; and displaying the text input in the first textarea in the second textarea in a second predetermined format, such that the input text is displayed at the same positions in the first textarea and in the second textarea, and that the input text is displayed superposedly in the first predetermined format and in the second predetermined format.

Optionally, therein, the second predetermined format is one in which a first predetermined number of preceding words in the text input by a user are displayed in a first predetermined color, and the subsequent words in the text input by the user are displayed in a second predetermined color or in a selected state.

Optionally, therein, the second predetermined format is one in which a first predetermined number of preceding words in the text input by a user are displayed in a first predetermined color, and the subsequent words in the text input by the user are displayed in blank.

Optionally, therein, words in the text input by a user are divided into multiple groups from beginning to end in a second predetermined number, and the second predetermined format is one in which words in each neighboring group are displayed in a different color.

According to another aspect of the invention, there is provided an interface component for displaying an input text comprising: a first textarea configured to receive a text input by a user and display the text input by the user in the first textarea in a first predetermined format; a second textarea arranged behind the first textarea and corresponding to the position of the first textarea, wherein the text input by the user in the first textarea is displayed in the second textarea in a second predetermined format, and the text input by the user is displayed at the same positions in the first textarea and in the second textarea.

Optionally, the second textarea displays a first predetermined number of preceding words in the text input by the user in a first predetermined color, and displays the subsequent words in the text input by the user in a second predetermined color or in a selected state.

Optionally, the second textarea displays a first predetermined number of preceding words in the text input by the user in a first predetermined color, and displays the subsequent words in the text input by the user in blank.

Optionally, the second textarea divides words in the text input by the user into multiple groups from beginning to end in a second predetermined number, and the second predetermined format is one in which words in each neighboring group are displayed in a different color.

In the method for displaying an input text in an interface and the interface component for displaying an input text according to the invention, by disposing a first textarea and a second textarea in the interface, the second textarea being arranged behind the first textarea, such that the position of the second textarea corresponds to the position of the first textarea, such that the input text is displayed superposedly at the same positions in the first textarea and in the second textarea, and that the text in the displayed textarea in the interface can be automatically displayed according to different formats, the problem that an input text in a textarea can not be displayed automatically according to different formats can be solved, and a more friendly interface may be presented to the user.

According to a further aspect of the invention, there is provided a method for processing a text input in an interface comprising the steps of: disposing a first textarea in the interface; disposing a second textarea in the interface, the second textarea being arranged behind the first textarea, such that the position of the second textarea corresponds to the position of the first textarea; receiving an input text in the first textarea, and displaying the input text in a first predetermined format; and displaying the text input in the first textarea in the second textarea in a second predetermined format, such that the input text is displayed at the same positions in the first textarea and in the second textarea, and that the input text is displayed superposedly in the first predetermined format and in the second predetermined format; wherein the first textarea and the second textarea are multi-line textareas.

According to yet another aspect of the invention, there is provided a computer program comprising a computer readable code which causes a server to perform the method for displaying an input text in an interface as described above, when said computer readable code is running on the server.

According to still another aspect of the invention, there is provided a computer readable medium storing therein the method for displaying an input text in an interface as described above.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings,

FIG. 1 shows a flow chart of a method for displaying an input text in an interface according to an embodiment of the invention;

FIG. 2 shows a schematic diagram of an input text being displayed superposedly in a first predetermined format in a first textarea and in a second predetermined format in a second textarea according to an embodiment of the invention; and

FIG. 3 shows a block schematic diagram of an interface component for displaying an input text according to an embodiment of the invention.

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

When a user inputs one or more segment of text in a textarea, the one or more segment of text in the textarea will only show a default font color (e.g., black), however, in some cases, the user may need to distinguishably display different parts of the text in multiple font colors, for example, to automatically display the part of the text in the textarea exceeding a maximum allowable number of words in red (or other color). Or, when a terminal user is editing a short message in a textarea, every 70 words in the textarea will show one color, that is, taking 70 words as a unit, the text in the textarea is divided into multiple parts, and each part shows a different color, so as to let the user clearly know how much money the short message currently edited needs to cost. However, the existing textarea does not have the functions of automatically setting an input text in a textarea to different formats and displaying it.

In this connection, the invention proposes a method for displaying an input text in an interface and an interface component for displaying an input text. For the convenience of illustration, in the following description, suppose that the plane of the interface is XY plane, and the laminating direction of the first textarea and the second textarea in the interface is the Z-axis direction of the interface, for example, the interface may be a webpage interface or a short message edit interface.

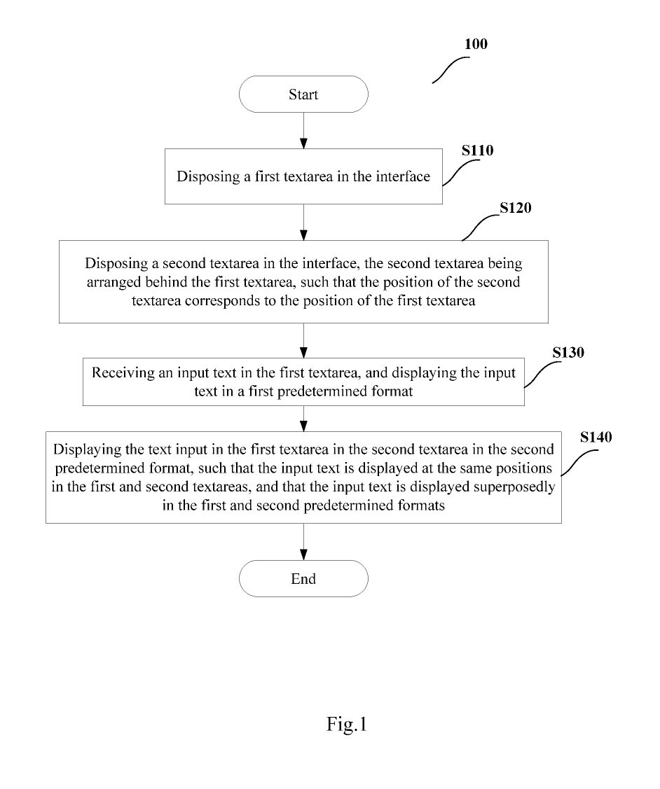

The method for displaying an input text in an interface proposed by the invention lies mainly in that in the Z-axis direction of the interface, under a first textarea is added a second textarea, an input text is received by the first textarea, and the input text is displayed at the same positions in the first textarea and the second textarea, such that the input text is displayed superposedly in a first predetermined format in the first textarea and in a second predetermined format in the second textarea. In the following, a flow chart of the method 100 for displaying an input text in an interface suitable for solving the above problem according to an embodiment of the invention is described particularly in connection with FIG. 1.

As shown in FIG. 1, the method 100 for displaying an input text in an interface of the invention begins in step S110. In step S110, a first textarea is disposed in the interface. The first textarea may be a movable text or graphics container with an adjustable size. According to an embodiment of the invention, the first textarea may be a multi-line textarea.

Next, in step S120, a second textarea is disposed in the interface, and the second textarea is arranged behind the first textarea, such that the position of the second textarea corresponds to the position of the first textarea. The second textarea may be a movable text or graphics container with an adjustable size. According to an embodiment of the invention, the second textarea may be a multi-line textarea.

In particular, in order to improve the display effect of the textarea in the interface, an attribute such as the position and size, etc. shown in the XY plane of the interface related with the first textarea is copied to the second textarea, such that the position and size of the second textarea shown in the XY plane of the interface are consistent with those of the first textarea. Additionally, for displaying properly, it is needed to set the first textarea above the second textarea in the Z-axis direction of the interface. According to an example of the invention, a defined attribute value of the laminating order in which the first textarea and the second textarea are displayed in the Z-axis direction of the interface may be set utilizing an attribute parameter z-index of the interface; the higher the value of z-index, the more an object is displayed above in the Z-axis direction of the interface; and the lower the value of z-index, the more an object is displayed below in the Z-axis direction of the interface. Of course, the invention is not limited to the attribute parameter z-index of the interface, and all the interface attributes which may define the laminating order in which the textareas are displayed in the interface are within the protection scope of the invention.

An example is taken in which the above interface supports the IE browser, and the first textarea and the second textarea are multi-line textareas. In step S110, a multi-line textarea textEl (corresponding to the first textarea) is disposed in the interface. Then, in step S120, a multi-line textarea bgEL (corresponding to the second textarea) is disposed in the interface, such that the style of the multi-line textarea bgEl is set to be identical to that of the multi-line textarea textEl, and yet the style of the multi-line textarea bgEl may only need to retain the attribute parameters, the width “width” and the height “height” of the multi-line textarea textEl, which may be represented particularly with the following codes:

// define a multi-line textarea textEl and a multi-line textarea bgEl
Dom.ready(function( ){

var textEl = g(‘msg’),

bgEl = g(‘bgTextarea’);

}
// the maximum allowable number of words in the multi-line textarea textEl is

50 words, and when exceeding 50 words, the font color of the exceeding part is set to be red

function shadow( ){

var valueStr=textEl.value,

subS = valueStr.substr(0,50);

bgEl.innerText = subS.replace(/\r/ig,“”);
var highLightEl = document.createElement(‘<font color=“red”>

</font>');

bgEl.appendChild(highLightEl);
highLightEl.innerText = valueStr.substr(subS.length).replace(

/([\r\n])$/,‘$1 ’).replace(/\r/ig,“”);

}

// the transparency of the multi-line textarea textEl and the font therein may be

set to be 0.2

if(Browser.ie && textEl) {

W(bgEl).show( );
W(textEl).css(‘opacity’,0.2)

.addEventListener(‘propertychange’,shadow).fire(

‘propertychange’)

```
  .addEventListener(‘scroll’,scroll).fire(‘scroll’)
  .addEventListener(‘selectionchange’,scroll);
```

};

//the font size of an input text in the multi-line textarea textEl is set to be 10

pounds

</script> </head><body>
<div style=“font-size:10pt;”><br/><hr/></div>
// the scrollbar of the multi-line textarea bgEl changes with the scrollbar of the

multi-line textarea textEl

function scroll( ){

bgEl.scrollTop = textEl.scrollTop;

}

//the style of the multi-line textarea bgEl is set to be identical to that of the multi-line textarea textEl, and the multi-line textarea bgEl is disposed below the multi-line textarea textEl:

<textarea id=“bgTextarea”

style=“width:300px;height:100px;line-height:20px;position:absolute;z-index:−1;display:none;” rows=“1” cols=“20” tabindex=“−1”></textarea>

<textarea id=“msg”

//in the multi-line textarea textEl is input “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day”

style=“width:300px;height:100px;line-height:20px;position:absolute” rows=“1” cols=“20”>Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day</textarea>

The above codes are described taking that the interface supports the IE browser as an example, and of course, it may be appreciated that, for a browser such as chrome and firefox, etc., although the label <font> can not be added in the codes for a browser such as the chrome and firefox, etc., the above codes may be adjusted, for example, in the multi-line textarea bgEl, the part of the text in the multi-line textarea textEl exceeding the maximum allowable number of words is replaced with predetermined words (e.g., replaced with spaces with equal width), so by means that the input text is displayed superposedly in the first predetermined format in the multi-line textarea textEL and in the second predetermined format in the multi-line textarea bgEl, the part of the text in the multi-line textarea textEl within the maximum allowable number of words can be displayed.

Next, in step S130, an input text is received in the first textarea, and the input text is displayed in a first predetermined format. In an embodiment of the invention, the first predetermined format is partially transparent, for example, the first predetermined format refers to a format in which the transparency (Alpha) of the text is 0.2 (the range of the transparency is 0˜225), and at this point, the text received in the first textarea will be displayed in the first textarea in a format in which the transparency is 0.2.

By setting the format of the text displayed in the first textarea to be the first predetermined format, the text in the first textarea can be differentiated from the text displayed in the second textarea in the second predetermined format. Of course, it may be appreciated that all the relevant parameters which may be used for setting the format of the text in the first textarea are within the protection scope of the invention.

Next, in step S140, the text input in the first textarea is displayed in the second textarea in the second predetermined format, such that the input text is displayed at the same positions in the first textarea and in the second textarea, and that the input text is displayed superposedly in the first predetermined format and in the second predetermined format.

In an embodiment of the invention, the second predetermined format is one in which a first predetermined number of preceding words in the text input by a user are displayed in a first predetermined color, and the subsequent words in the text input by the user are displayed in a second predetermined color.

For example, the first predetermined format may be set to be partially transparent, the first predetermined color may be set to be black, the second predetermined color is red, and the first predetermined number of words may be set to be 50 words. In step S130, the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is received in the first textarea, and the above text is displayed in the first textarea in a format of being partially transparent. Subsequently, in step S140, the preceding 50 words in the above text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” are displayed in the second textarea in black font, the part of the text “Why need stay together night and day” exceeding the preceding 50 words is displayed in red font, and then the text in the first textarea and the text in the second textarea are displayed superposedly.

Although the second textarea is disposed below the first textarea in the Z-axis direction of the interface, since the position and size of the first textarea in the XY plane of the interface are the same as those of the second textarea, and since the text in the first textarea is displayed to be partially transparent, the colors of the second textarea and the text therein will be transmitted through the first textarea and the text therein and displayed, such that the text in the superposed textarea seen by the user in the interface is in fact the text in the second textarea, that is, the font color of the part of the text showing “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is black, and the font color of the part of the text showing “Why need stay together night and day” is red. Thereby, it is achieved that an input text in the first textarea is displayed automatically in different colors.

Further, by adjusting the first predetermined number, such that the text input in the first textarea can produce an effect of different colors in vision and effect, a function of humanizedly prompting that the predetermined number of words is exceeded can be realized. For example, the number of words in a textarea in weibo.com is not allowed to exceed 140 words, and by employing the invention, the font color of the part of the text in the textarea exceeding 140 words may be displayed in red to prompt that the current number of words in the textarea does not meet the requirement, and the part that does not meet the requirement is displayed in the form of red font. Of course, it may be appreciated that in embodiments of the invention, the particular colors of the first predetermined color and the second predetermined color are not defined particularly, and the particular numerical value of the first predetermined number is not be defined.

In another embodiment of the invention, the second predetermined format is one in which a first predetermined number of preceding words in the text input by a user are displayed in a first predetermined color, and the subsequent words in the text input by the user are displayed in a selected state.

For example, the first predetermined format may be set to be partially transparent, the first predetermined color may be set to be black, the selected state may be set as displaying in grey or highlight a selected part of the text, and the first predetermined number of words may be set to be 50 words. In step S130, the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is received in the first textarea, and the above text is displayed in the first textarea in a format of being partially transparent. Subsequently, in step S140, the preceding 50 words in the above text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” are displayed in the second textarea in black font, and the part of the text “Why need stay together night and day” exceeding the preceding 50 words is displayed in grey or highlight. Then the text in the first textarea and the text in the second textarea are displayed superposedly.

Although the second textarea is disposed below the first textarea in the Z-axis direction of the interface, since the position and size of the first textarea in the XY plane of the interface are the same as those of the second textarea, and since the text in the first textarea is displayed to be partially transparent, the second textarea and the text therein will be transmitted partially through the first textarea and the text therein, such that the superposed text seen in the interface is in fact the text in the second textarea, that is, the font color in which the part of the text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is displayed is black, and the part of the text “Why need stay together night and day” is displayed in grey or highlight.

Thereby, by employing the first textarea and the second textarea corresponding to the first textarea, it is achieved that an input text is automatically displayed in different colors. Further, by adjusting the first predetermined number, such that the text input in the first textarea can produce an effect of different colors in vision and effect, a function of humanizedly prompting that the predetermined number of words is exceeded can be realized. For example, the number of words in a textarea in weibo.com is not allowed to exceed 140 words, and by employing embodiments of the invention, the part of the text in the textarea exceeding 140 words may be displayed in grey or highlight to prompt that the current number of words in the textarea does not meet the requirement, and the part that does not meet the requirement is displayed in a way of displaying in grey or highlight. Of course, it may be appreciated that in embodiments of the invention, the particular color of the first predetermined color, the display way of the selected state, and the particular numerical value of the first predetermined number are not be defined particularly.

In yet another embodiment of the invention, the second predetermined format is one in which a first predetermined number of preceding words in the text input by a user are displayed in a first predetermined color, and the subsequent words in the text input by the user are displayed in blank.

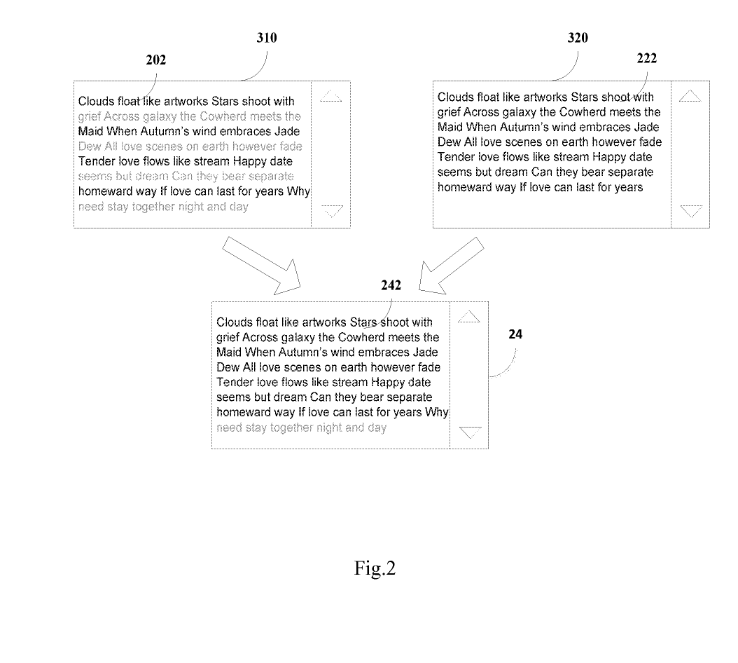

Referring to FIG. 2, for example, the first predetermined format may be set to be partially transparent, the first predetermined color may be set to be black, displaying in blank may refer to replacing a word with a space, and the first predetermined number of words may be set to be 50 words. In step S130, the following text 202 (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is received in the first textarea 310, and the format of the above text is set to be partially transparent. Subsequently, in step S140, the following text 222 (the text part with the preceding 50 words in the text 202) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for year” is displayed in the second textarea 320 in black font, the part of the text “Why need stay together night and day” exceeding the preceding 50 words is replaced with spaces with an equal width, that is, the above part of the text exceeding the preceding 50 words is replaced with 7 spaces, the input text is displayed at the same positions in the first textarea 310 and the second textarea 320, the input text is displayed superposedly in the first predetermined format and in the second predetermined format, and finally the text 242 is obtained. Although the second textarea 320 is disposed below the first textarea 310 in the Z-axis direction of the interface, since the position and size of the first textarea 310 in the XY plane of the interface are the same as those of the second textarea 320 (in FIG. 2, just for the convenience of illustration, the first textarea 20 and the second textarea 22 are arranged in different areas), the user will see a superposed textarea 24 in the interface, and still since the text 202 in the first textarea 310 is displayed to be partially transparent, it is seen in the interface that a superposed text 242 will be displayed in a superposed textarea 24, that is, the font color of the part of the text showing “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is black, and the part of the text showing “Why need stay together night and day” is partially transparent (part of the text in the first textarea 310). Thereby, by employing the first textarea and the second textarea corresponding to the first textarea, it is achieved that the part of the text input in the first textarea exceeding a maximum displayable number of words is automatically displayed in blank. Of course, it may be appreciated that in embodiments of the invention, the particular color of the first predetermined color is not defined particularly, and the particular numerical value of the first predetermined number is not be defined.

In still another embodiment of the invention, in step S140, in the second textarea, words in the text input by a user are divided into multiple groups from beginning to end in a second predetermined number, and the second predetermined format is one in which words in each neighboring group are displayed in a different color.

For example, the second predetermined number is 50 words, and the first predetermined format may be set to be partially transparent, and the different color may comprise blue and red. In step S130, the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is received in the first textarea 310, and the format of the above text is set to be partially transparent. Subsequently, in step S140, the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is displayed in the second textarea 320 in a way in which the blue font and the red font are interlaced per 50 words, that is, the font color of “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is displayed to be blue, and the font color of “Why need stay together night and day” is displayed to be red, and then the text in the first textarea and the text in the second textarea are displayed superposedly. Although the second textarea is disposed below the first textarea in the Z-axis direction of the interface, since the position and size of the first textarea in the XY plane of the interface are the same as those of the second textarea, and since the text in the first textarea is displayed to be partially transparent, the second textarea will be transmitted partially through the first textarea, such that the superposed text seen in the interface is in fact the text in the second textarea, that is, the font color of the part of the text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is displayed to be blue, and the color of the part of the text “Why need stay together night and day” is displayed to be red. Thereby, by employing the first textarea and the second textarea corresponding to the first textarea, it is achieved that an input text is automatically displayed in different colors. For example, the second predetermined number is set to be 70 words, and when editing a mobile phone short message, in a short message textarea, a text input by a user may be set to be in a way in which one color is displayed per 70 words, and thereby the user may be let to clearly know how much his own short message will cost. Of course, it may be appreciated that in embodiments of the invention, the particular numerical value of the second predetermined number is not be defined particularly, and the selection of different colors is not defined.

After step S140, the flow may be ended. It needs to be noted that, the method as shown in FIG. 1 is not defined to be performed in the order of the individual steps as shown, and the order of the individual steps may be adjusted as desired. In addition, the steps are also not defined to the above step division, and the above steps may be further split into more steps, or also may be merged into fewer steps. For example, “a second textarea is disposed in the interface” in step S120 may be performed together with step S110, whereas in step S120, the position between the first textarea and the second textarea is set.

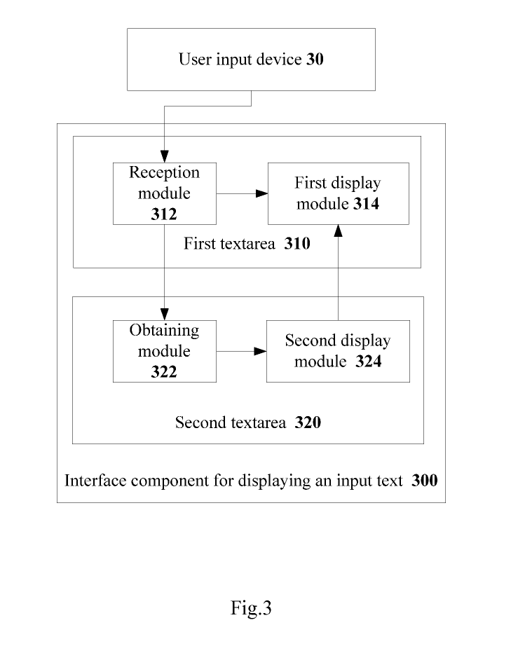

In the following, an interface component 300 for displaying an input text suitable for solving the above problem according to an embodiment of the invention is described in connection with FIG. 3.

As shown in FIG. 3, the interface component 300 for displaying an input text of the invention comprises: a first textarea 310 and a second textarea 320, and for the convenience of description, FIG. 3 further shows a user input device 30.

The first textarea 310 receives a text input by a user from the user input device 30 and display the text input by the user in the first textarea 310 in a first predetermined format; and the user input device 30 may be a keyboard for inputting a text, or may also be a touch display screen for a user to input a text. In an embodiment of the invention, the first predetermined format is partially transparent.

Optionally, the first textarea 310 comprises a reception module 312 and a first display module 314, wherein the reception module 312 receives a text input by a user from the user input device 30, and the first display module 314 displays the text input by the user in the first predetermined format.

In the Z-axis direction of the interface, the second textarea 320 is arranged below the first textarea 310 and corresponds to the position of the first textarea 310, the text input by the user in the first textarea 310 is displayed in the second textarea 320 in a second predetermined format, and the text input by the user is displayed at the same positions in the first textarea 310 and in the second textarea 320.

Optionally, the second textarea 320 comprises an obtaining module 322 and a second display module 324, wherein the obtaining module 322 obtains the text input by the user in the first textarea 310, and the second display module 324 displays the obtained text in the second predetermined format.

In particular, in order to improve the display effect of the textarea in the interface, an attribute such as the position and size, etc. shown in the XY plane of the interface related with the first textarea 310 is copied to the second textarea 320, such that the position and size of the second textarea 320 shown in the XY plane of the interface are consistent with those of the first textarea 310. Additionally, for displaying properly, it is needed to set the first textarea 310 above the second textarea 320 in the Z-axis direction of the interface. According to an example of the invention, a defined attribute value of the laminating order in which the first textarea 310 and the second textarea 320 are displayed in the Z-axis direction of the interface may be set utilizing an attribute parameter z-index of the interface; the higher the value of z-index, the more an object is displayed above in the Z-axis direction of the interface; and the lower the value of z-index, the more an object is displayed below in the Z-axis direction of the interface. Of course, the invention is not limited to the attribute parameter z-index of the interface, and all the interface attributes which may define the laminating order in which the textareas are displayed in the interface are within the protection scope of the invention.

In an embodiment of the invention, the second textarea 320 displays a first predetermined number of preceding words in the text input by the user in a first predetermined color, and displays the subsequent words in the text input by the user in a second predetermined color or in a selected state.

For example, the first predetermined format may be set to be partially transparent, the first predetermined color may be set to be black, the selected state may be set as displaying in grey or highlight a selected part of the text, and the first predetermined number of words may be set to be 50 words. The reception module 312 in the first textarea 310 receives the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day”, and the first display module 314 displays the above text in a format of being partially transparent. The obtaining module 322 in the second textarea 320 obtains the text input by the user in the first textarea 310, the second display module 324 in the second textarea 320 displays the preceding 50 words in the above text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in black font, and the part of the text “Why need stay together night and day” exceeding the preceding 50 words is displayed in grey or highlight. Then the text in the first textarea 310 and the text in the second textarea 320 are displayed superposedly. Although the second textarea 320 is disposed behind the first textarea 310, since the position and size of the first textarea 310 in the interface are the same as those of the second textarea 320, the user will only see a superposed textarea in the interface, and still since the text in the first textarea 310 is displayed to be partially transparent, in the textarea seen in the interface, a superposed text will be displayed, that is, the font color of the part of the text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is black, and the part of the text “Why need stay together night and day” is displayed in grey or highlight. Thereby, by employing the first textarea 310 and the second textarea 320 corresponding to the first textarea 310, it is achieved that the text input in the first textarea 310 is automatically displayed in different colors.

In another embodiment of the invention, the second textarea 320 displays a preceding first predetermined number of words in the text input by the user in a first predetermined color, and displays the subsequent words in the text input by the user in blank.

For example, the first predetermined format may be set to be partially transparent, the first predetermined color may be set to be black, displaying in blank may refer to replacing a word with a space, and the first predetermined number of words may be set to be 50 words. In connection with FIG. 2, the reception module 312 in the first textarea 310 receives the following text 202 (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day”, and the first display module 314 displays the above text in a format of being partially transparent. The obtaining module 322 in the second textarea 320 obtains the text input by the user in the first textarea 310, the second display module 324 in the second textarea 320 displays the following text 222 (the text part with the preceding 50 words in the text 202) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in black font, the part of the text “Why need stay together night and day” exceeding the preceding 50 words is replaced with spaces with an equal width, that is, the above part of the text exceeding the preceding 50 words is replaced with 7 spaces, the input text is displayed at the same positions in the first textarea 310 and the second textarea 320, the input text is displayed superposedly in the format in the first textarea 310 and in the format in the second textarea 320, and thereby the text 242 is obtained. Although the second textarea 320 is disposed behind the first textarea 310, since the position and size of the first textarea 310 in the interface are the same as those of the second textarea 320 (in FIG. 2, just for the convenience of illustration, the first textarea 310 and the second textarea 320 are arranged in different areas), the user will see a superposed textarea 24 and a superposed text 242 in the interface, and the display effect of the text 242 lies in that the font color of the part of the text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” is black, and the part of the text “Why need stay together night and day” is displayed in grey or highlight. Thereby, by employing the first textarea 310 and the second textarea 320 corresponding to the first textarea 310, it is achieved that the part of the text input in the first textarea 310 exceeding a maximum displayable number of words is automatically displayed in blank. Of course, it may be appreciated that in embodiments of the invention, the particular color of the first predetermined color is not defined particularly, and the particular numerical value of the first predetermined number is not be defined.

In still another embodiment of the invention, the second textarea 320 divides words in the text input by the user into multiple groups from beginning to end in a second predetermined number, and the second predetermined format is one in which words in each neighboring group are displayed in a different color.

For example, the second predetermined number is 50 words, the first predetermined format may be set to be partially transparent, and the different color may comprise blue and red. The reception module 312 in the first textarea 310 receives the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day”, and the first display module 314 displays the above text in a format of being partially transparent. The obtaining module 322 in the second textarea 320 obtains the text input by the user in the first textarea 310, in the second display module 324 the above text is divided into two groups per 50 words, the font color of the first group being blue font, and the font color of the second group being red font, that is, the following text (totally 57 words) “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years Why need stay together night and day” is displayed in a way in which the blue font and the red font are interlaced, that is, the font color of “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” in the interface is displayed to be blue, and the font color of “Why need stay together night and day” is displayed to be red, and then the text in the first textarea 310 and the text in the second textarea 320 are displayed superposedly. Although the second textarea 320 is disposed behind the first textarea 310 in the Z-axis direction of the interface, since the position and size of the first textarea 310 in the XY plane of the interface are the same as those of the second textarea 320, in the display interface the user will only see a superposed textarea and a superposed text that is displayed, and the display effect of the superposed text lies in that the font color of the part of the text “Clouds float like artworks Stars shoot with grief Across galaxy the Cowherd meets the Maid When Autumn's wind embraces jade dew All love scenes on earth however fade Tender love flows like stream Happy date seems but dream Can they bear separate homeward way If love can last for years” is displayed to be blue, and the color of the part of the text “Why need stay together night and day” is displayed to be red. Thereby, by employing the first textarea 310 and the second textarea 320 corresponding to the first textarea 310, it is achieved that an input text is automatically displayed in different colors. For example, the second predetermined number is set to be 70 words, and when editing a mobile phone short message, in a short message textarea, a text input by a user may be set to be in a way in which one color is displayed per 70 words, and thereby the user may be let to clearly know how much his own short message will cost. Of course, it may be appreciated that in embodiments of the invention, the particular numerical value of the second predetermined number is not be defined particularly, and the selection of different colors is not defined.

It is to be specifically noted that, the algorithms and displays provided here are not inherently related to any specific computer, virtual system or other apparatus. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or components may be combined into one module or unit or component, and additionally, they may be divided into multiple sub-modules or sub-units or sub-components. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in embodiments according to the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

1. A method for displaying an input text in an interface comprising the steps of:
disposing a first textarea in the interface;
disposing a second textarea in the interface, the second textarea being arranged behind the first textarea, such that the position of the second textarea corresponds to the position of the first textarea;
receiving an input text in the first textarea, and displaying the input text in a first predetermined format; and
displaying the text input in the first textarea in the second textarea in a second predetermined format, such that the input text is displayed at the same positions in the first textarea and in the second textarea, and that the input text is displayed superposedly in the first predetermined format and in the second predetermined format.

2. The method as claimed in claim 1, wherein the first textarea and the second textarea are multi-line textareas.

3. The method as claimed in claim 1, wherein the first predetermined format is partially transparent.

4. The method as claimed in claim 1, wherein the second predetermined format is one in which a first predetermined number of preceding words in the text input by the user are displayed in a first predetermined color, and the subsequent words in the text input by the user are displayed in a second predetermined color or in a selected state.

5. The method as claimed in claim 1, wherein the second predetermined format is one in which a first predetermined number of preceding words in the text input by the user are displayed in a first predetermined color, and the subsequent words in the text input by the user are displayed in blank.

6. The method as claimed in claim 1, wherein the words in the text input by the user are divided into multiple groups from beginning to end in a second predetermined number, and the second predetermined format is one in which the words in each neighboring group are displayed in a different color.

7. An interface component for displaying an input text comprising:
a first textarea configured to receive a text input by a user and display the text input by the user in the first textarea in a first predetermined format; and
a second textarea arranged behind the first textarea and corresponding to the position of the first textarea, wherein the text input by the user in the first textarea is displayed in the second textarea in a second predetermined format, and the text input by the user is displayed at the same positions in the first textarea and in the second textarea.

8. The interface component as claimed in claim 7, wherein the first textarea and the second textarea are multi-line textareas.

9. The interface component as claimed in claim 7, wherein the first predetermined format is partially transparent.

10. The interface component as claimed in claim 7, wherein
the second textarea displays a first predetermined number of preceding words in the text input by the user in a first predetermined color, and displays the subsequent words in the text input by the user in a second predetermined color or in a selected state.

11. The interface component as claimed in claim 7, wherein
the second textarea displays a first predetermined number of preceding words in the text input by the user in a first predetermined color, and displays the subsequent words in the text input by the user in blank.

12. The interface component as claimed in claim 7, wherein
the second textarea divides the words in the text input by the user into multiple groups from beginning to end in a second predetermined number, and the second predetermined format is one in which the words in each neighboring group are displayed in a different color.

13. The interface component as claimed in claim 7, wherein
the first textarea comprises:
a reception module configured to receive the text input by the user; and
a first display module configured to display the text input by the user in the first predetermined format.

14. The interface component as claimed in claim 7, wherein
the second textarea comprises:
an obtaining module configured to obtain the text input by the user in the first textarea; and
a second display module configured to display the obtained text in the second predetermined format.

15. (canceled)

16. (canceled)

17. A non-transitory computer readable medium having instructions stored thereon that, when executed by at least one processor, cause the at least one processor to perform operations for displaying an input text in an interface, which comprises the steps of:
disposing a first textarea in the interface;
disposing a second textarea in the interface, the second textarea being arranged behind the first textarea, such that the position of the second textarea corresponds to the position of the first textarea;
receiving an input text in the first textarea, and displaying the input text in a first predetermined format; and
displaying the text input in the first textarea in the second textarea in a second predetermined format, such that the input text is displayed at the same positions in the first textarea and in the second textarea, and that the input text is displayed superposedly in the first predetermined format and in the second predetermined format.
